(19) United States
(12) Patent Application Publication
(10) Pub. No.: US 2012/0291594 A1
(43) Pub. Date: Nov. 22, 2012

(54) Ratchet Wrench with a Sliding Drive Head

(76) Inventors: Yu-Lan Lai Li, Taichung City (TW); Yui-Ji Huang, Taichung City (TW)

(21) Appl. No.: 13/108,032

(22) Filed: May 16, 2011

(51) Int. Cl. B25B 13/46

(52) U.S. Cl. 81/60

(57) ABSTRACT

A ratchet wrench includes a wrench body, a control wheel mounted in the wrench body, a control shaft mounted in the wrench body and having a pressing recess, a drive head movably mounted on the control shaft and having a positioning hole, a positioning ball movably mounted in the positioning hole of the drive head and movable into the pressing recess of the control shaft, and an elastic member biased between the control shaft and the drive head. Thus, when the wrench body is moved toward the socket, the drive head is forced by the socket and moved on the control shaft to align the positioning hole of the drive head with the pressing recess of the control shaft and to retract the positioning ball into the positioning hole of the drive head so that the socket is connected with the drive head.

### BACKGROUND OF THE INVENTION

1. Field of the Invention

The present invention relates to a hand tool and, more particularly, to a ratchet wrench.

2. Description of the Related Art

A conventional ratchet wrench comprises a wrench body, a ratchet wheel mounted in the wrench body, a drive head mounted on the ratchet wheel and having an inner portion provided with a receiving hole and a peripheral wall provided with a positioning hole connected to the receiving hole, a control shaft movably mounted in the receiving hole of the drive head and having an upper end protruding from the top of the wrench body and a lower end provided with a pressing recess, a positioning ball movably mounted in the positioning hole of the drive head and movable into the pressing recess of the control shaft, and an elastic member mounted on the control shaft and biased between the control shaft and the drive head to push the control shaft outward relative to the drive head.

In operation, the ratchet wrench is used to drive a socket so as to operate a workpiece, such as a bolt, nut and the like. The socket has an inner portion provided with a mounting hole which has a peripheral wall provided with a locking groove. When the socket is mounted on the drive head of the ratchet wrench, the upper end of the control shaft is pressed downward to align the pressing recess of the control shaft with the positioning hole of the drive head so as to move the positioning ball into the pressing recess of the control shaft and to retract the positioning ball into the positioning hole of the drive head so that the socket can be mounted on the drive head of the ratchet wrench. When the locking groove of the socket aligns with the positioning hole of the drive head and the positioning ball, the control shaft is pushed upward by the restoring force of the elastic member, and the pressing recess of the control shaft is moved upward to press the positioning ball outward so that the positioning ball is moved outward to partially protrude outward from the positioning hole of the drive head and is inserted into and locked in the locking groove of the socket, and the socket is locked onto the drive head.

However, the user has to press the control shaft so as to retract the positioning ball into the positioning hole of the drive head to facilitate insertion of the drive head of the ratchet wrench into the socket so that the user has to hold the socket by his one hand and to press the control shaft by the other hand, thereby causing inconvenience to the user in combination of the drive head of the ratchet wrench with the socket.

### BRIEF SUMMARY OF THE INVENTION

In accordance with the present invention, there is provided a wrench, comprising a wrench body having an inner portion provided with a receiving space, a control wheel mounted in the receiving space of the wrench body, a control shaft mounted in the receiving space of the wrench body and having a periphery provided with a pressing recess, a drive head movably mounted on the control shaft and having a peripheral wall provided with a positioning hole, a positioning ball movably mounted in the positioning hole of the drive head and movable into the pressing recess of the control shaft, and an elastic member mounted on the control shaft and biased between the control shaft and the drive head.

The primary objective of the present invention is to provide a ratchet wrench with a sliding drive head.

According to the primary advantage of the present invention, when the wrench body is moved toward the socket, the drive head is forced by the socket to move on the control shaft so as to align the positioning hole of the drive head with the pressing recess of the control shaft and to retract the positioning ball into the positioning hole of the drive head so that the socket is locked onto and connected with the drive head easily and quickly.

According to another advantage of the present invention, when the wrench body is moved toward the socket, the socket is locked onto the drive head automatically by moving of the drive head so that the user needs not to press the control shaft for connecting the drive head with the socket, thereby facilitating the user connecting the ratchet wrench with the socket.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a ratchet wrench in accordance with the preferred embodiment of the present invention.

FIG. 2 is an exploded perspective view of the ratchet wrench as shown in FIG. 1.

FIG. 3 is a front cross-sectional view of the ratchet wrench as shown in FIG. 1.

FIG. 4 is a schematic operational view of the ratchet wrench as shown in FIG. 3.

FIG. 5 is a schematic operational view of the ratchet wrench as shown in FIG. 4.

### DETAILED DESCRIPTION OF THE INVENTION

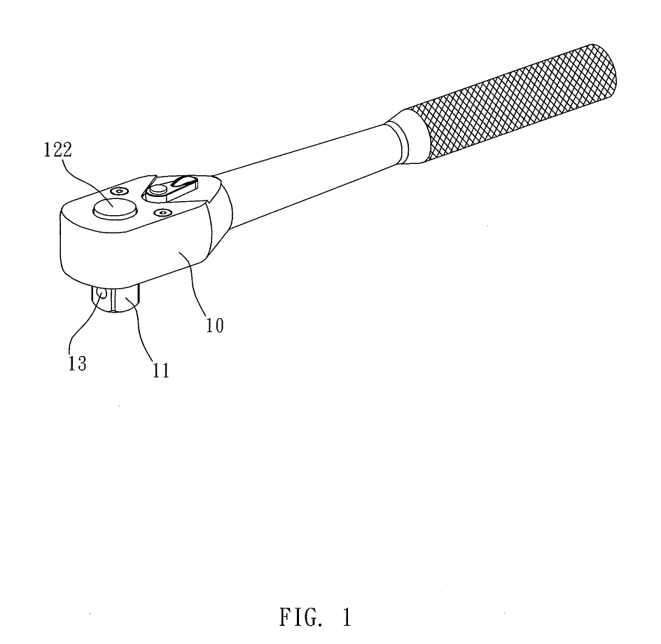

Referring to the drawings and initially to FIGS. 1-3, a ratchet wrench in accordance with the preferred embodiment of the present invention comprises a wrench body 10 having an inner portion provided with a receiving space 17, a control wheel 15 mounted in the receiving space 17 of the wrench body 10, a control shaft 12 mounted in the receiving space 17 of the wrench body 10 and having a periphery provided with a pressing recess 121, a drive head 11 movably mounted on the control shaft 12 and having a peripheral wall provided with a positioning hole 112, a positioning ball 13 movably mounted in the positioning hole 112 of the drive head 11 and movable into the pressing recess 121 of the control shaft 12, an elastic member 14 mounted on the control shaft 12 and biased between the control shaft 12 and the drive head 11, and a snap ring 16 mounted on the drive head 11 and abutting the wrench body 10.

The control wheel 15 is a ratchet wheel. The control wheel 15 has an inner portion provided with a receiving hole 151 to receive the drive head 11. The receiving hole 151 of the control wheel 15 has a stepped shape and has a mediate portion provided with a shoulder 152 to stop the snap ring 16.

The drive head 11 is movable in the receiving hole 151 of the control wheel 15 and is disposed between the control shaft 12 and the control wheel 15. The drive head 11 has a square shape and has an inner portion provided with a sliding hole 111 slidably mounted on the control shaft 12. The sliding hole 111 of the drive head 11 extends in an axial direction of the drive head 11 and extends through a whole length of the drive head 11. The sliding hole 111 of the drive head 11 is connected to the positioning hole 112 of the drive head 11 and the pressing recess 121 of the control shaft 12. The drive head 11 has an upper end provided with an abutting portion 113 and has a lower end provided with the positioning hole 112.

The positioning hole 112 of the drive head 11 and the positioning ball 13 are exposed outward from the receiving hole 151 of the control wheel 15 and the wrench body 10. The positioning hole 112 of the drive head 11 is movable to align with the pressing recess 121 of the control shaft 12 so that the positioning ball 13 is movable to align with the pressing recess 121 of the control shaft 12. Thus, when the positioning hole 112 of the drive head 11 is moved to misalign with the pressing recess 121 of the control shaft 12, the positioning ball 13 is pressed by the pressing recess 121 of the control shaft 12 and is moved to partially protrude outward from the positioning hole 112 of the drive head 11, and when the positioning hole 112 of the drive head 11 is moved to align with the pressing recess 121 of the control shaft 12, the positioning ball 13 is partially inserted into the pressing recess 121 of the control shaft 12 and is retracted into the positioning hole 112 of the drive head 11.

The snap ring 16 has a C-shaped profile. The snap ring 16 is secured on the abutting portion 113 of the drive head 11 and abuts the shoulder 152 of the control wheel 15 to stop the drive head 11.

The receiving space 17 of the wrench body 10 has a top wall provided with a stop flange 18.

The control shaft 12 has an upper end provided with a limit knob 122 abutting the wrench body 10 and has a lower end provided with the pressing recess 121. The limit knob 122 of the control shaft 12 is located under and stopped by the stop flange 18 of the wrench body 10. The pressing recess 121 of the control shaft 12 has an arc-shaped profile and is received in the sliding hole 111 of the drive head 11.

The elastic member 14 is received in the receiving hole 151 of the control wheel 15 and has an upper end abutting the limit knob 122 of the control shaft 12 and a lower end abutting the abutting portion 113 of the drive head 11.

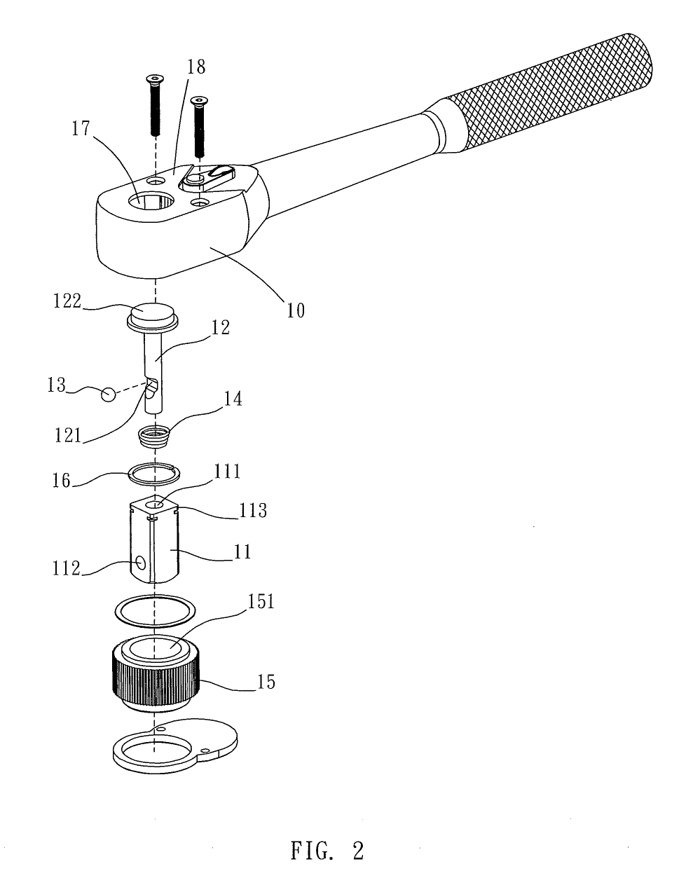

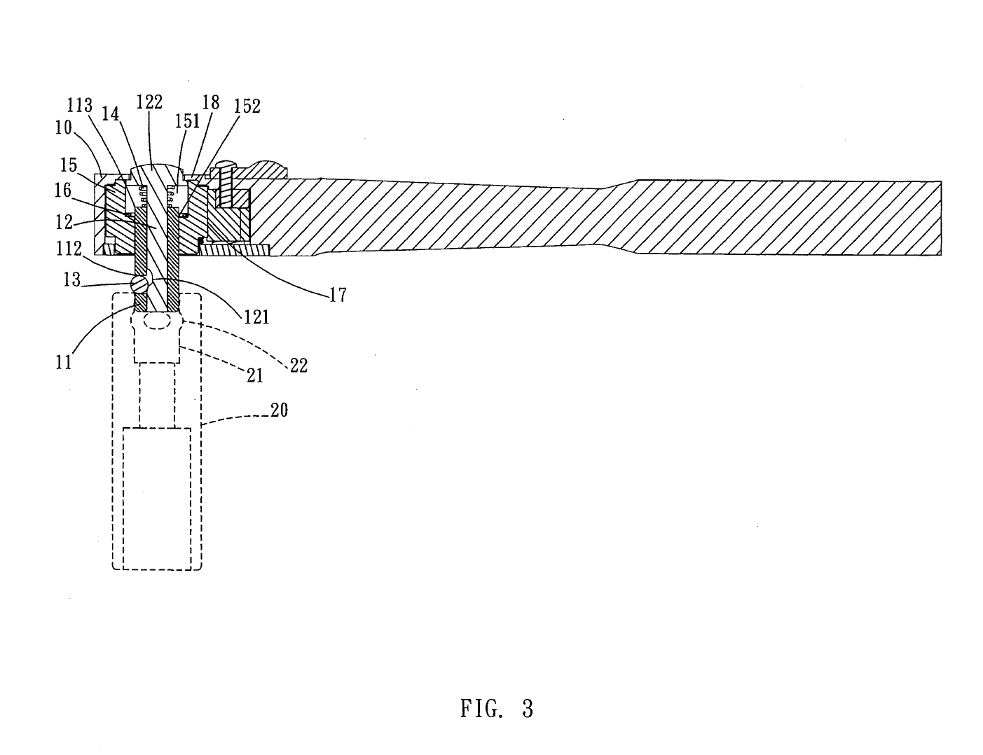

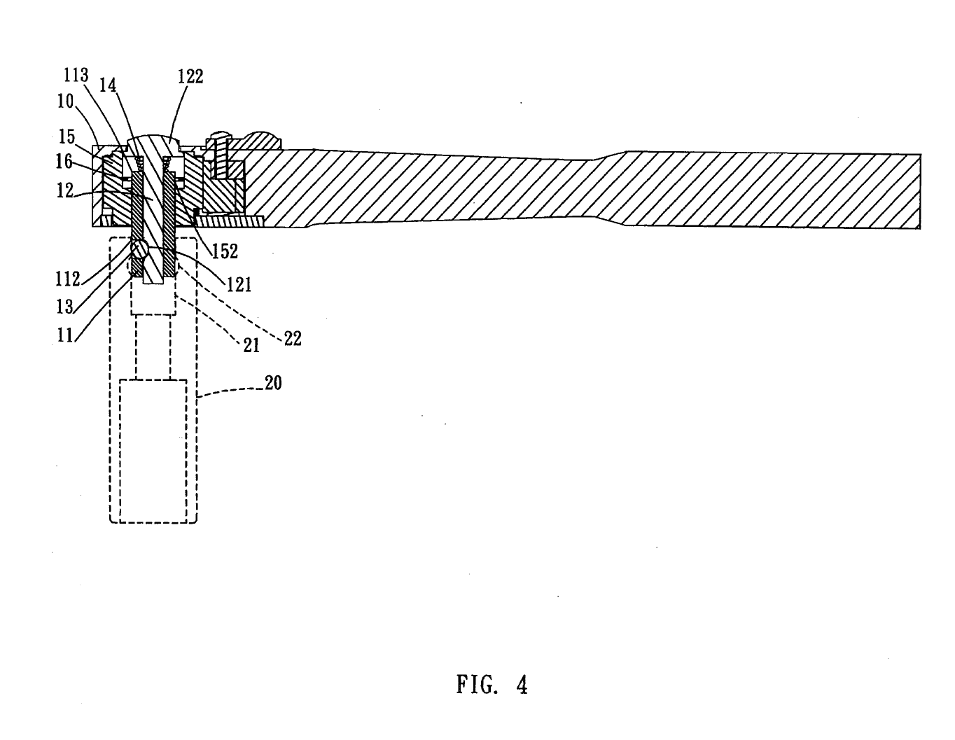

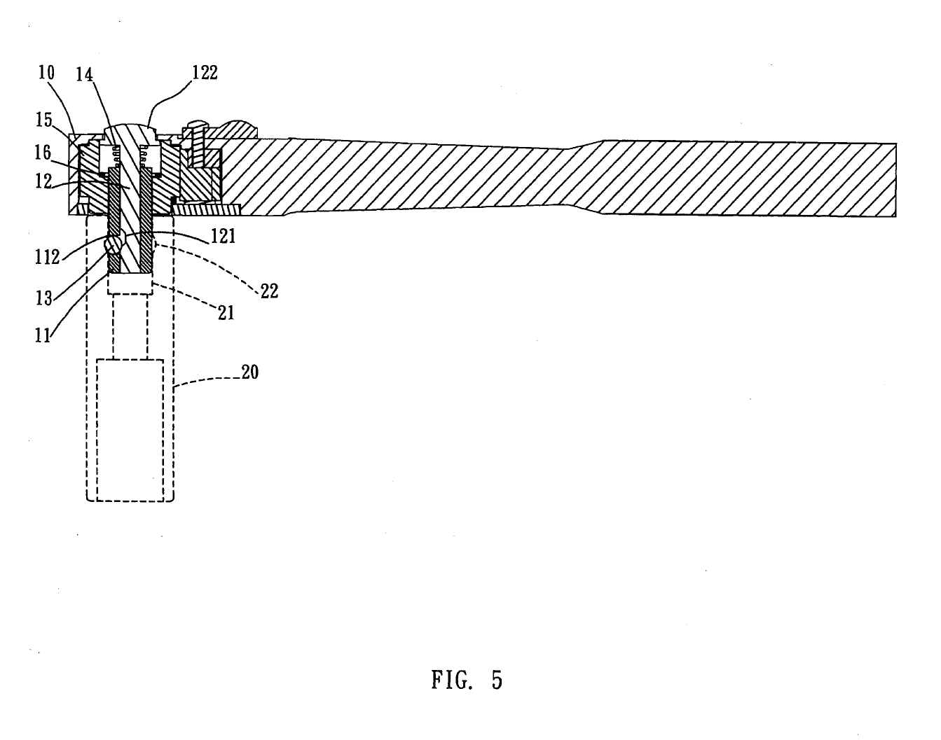

In operation, referring to FIGS. 3-5 with reference to FIGS. 1 and 2, the ratchet wrench is used to drive a socket 20 so as to operate a workpiece, such as a bolt, nut and the like. The socket 20 has an inner portion provided with a mounting hole 21 which has a peripheral wall provided with a locking groove 22. When a user applies a force on the wrench body 10 to move the drive head 11 toward the socket 20, the drive head 11 is inserted into the mounting hole 21 of the socket 20, so that the socket 20 abuts the drive head 11 and the positioning ball 13 as shown in FIG. 3. When the wrench body 10 is further moved toward the socket 20, the drive head 11 and the positioning ball 13 are pushed toward the wrench body 10 by push of the socket 20 so that the drive head 11 is moved on the control shaft 12 and is moved toward the limit knob 122 of the control shaft 12. At this time, the positioning ball 13 is moved upward in concert with the drive head 11. When the positioning hole 112 of the drive head 11 is moved to align with the pressing recess 121 of the control shaft 12 as shown in FIG. 4, the positioning ball 13 is still pushed by the socket 20 so that the positioning ball 13 is partially inserted into the pressing recess 121 of the control shaft 12 and is retracted into the positioning hole 112 of the drive head 11. When the wrench body 10 is further moved toward the socket 20 until the socket 20 abuts the bottom of the wrench body 10, the locking groove 22 of the socket 20 aligns with the positioning hole 112 of the drive head 11 and the positioning ball 13 as shown in FIG. 5. At this time, the drive head 11 is pushed downward by the restoring force of the elastic member 14, and the positioning hole 112 of the drive head 11 is moved downward to misalign with the pressing recess 121 of the control shaft 12, so that the positioning ball 13 is pressed by the pressing recess 121 of the control shaft 12 and is moved outward to partially protrude outward from the positioning hole 112 of the drive head 11. In such a manner, the positioning ball 13 is inserted into and locked in the locking groove 22 of the socket 20 by pressing of the pressing recess 121 of the control shaft 12 as shown in FIG. 5 so that the socket 20 is locked onto the drive head 11.

Accordingly, when the wrench body 10 is moved toward the socket 20, the drive head 11 is forced by the socket 20 to move on the control shaft 12 so as to align the positioning hole 112 of the drive head 11 with the pressing recess 121 of the control shaft 12 and to retract the positioning ball 13 into the positioning hole 112 of the drive head 11 so that the socket 20 is locked onto and connected with the drive head 11 easily and quickly. In addition, when the wrench body 10 is moved toward the socket 20, the socket 20 is locked onto the drive head 11 automatically by moving of the drive head 11 so that the user needs not to press the control shaft 12 for connecting the drive head 11 with the socket 20, thereby facilitating the user connecting the ratchet wrench with the socket 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A wrench, comprising:
a wrench body having an inner portion provided with a receiving space;
a control wheel mounted in the receiving space of the wrench body;
a control shaft mounted in the receiving space of the wrench body and having a periphery provided with a pressing recess;
a drive head movably mounted on the control shaft and having a peripheral wall provided with a positioning hole;
a positioning ball movably mounted in the positioning hole of the drive head and movable into the pressing recess of the control shaft; and
an elastic member mounted on the control shaft and biased between the control shaft and the drive head.

2. The wrench of claim 1, wherein the control wheel has an inner portion provided with a receiving hole to receive the drive head.

3. The wrench of claim 2, wherein the drive head is movable in the receiving hole of the control wheel.

4. The wrench of claim 1, wherein the drive head has an inner portion provided with a sliding hole slidably mounted on the control shaft.

5. The wrench of claim 4, wherein the sliding hole of the drive head is connected to the positioning hole of the drive head and the pressing recess of the control shaft.

6. The wrench of claim 1, wherein
the drive head has an upper end provided with an abutting portion;
the control shaft has an upper end provided with a limit knob abutting the wrench body;
the elastic member has an upper end abutting the limit knob of the control shaft and a lower end abutting the abutting portion of the drive head.

7. The wrench of claim 6, wherein
the drive head has a lower end provided with the positioning hole;
the control shaft has a lower end provided with the pressing recess.

8. The wrench of claim 6, wherein
the receiving space of the wrench body has a top wall provided with a stop flange;
the limit knob of the control shaft is located under and stopped by the stop flange of the wrench body.

9. The wrench of claim 1, wherein the control wheel is a ratchet wheel.

10. The wrench of claim 1, wherein the pressing recess of the control shaft has an arc-shaped profile.

11. The wrench of claim 4, wherein the pressing recess of the control shaft is received in the sliding hole of the drive head.

12. The wrench of claim 6, wherein the wrench further comprises a snap ring mounted on the drive head and abutting the wrench body.

13. The wrench of claim 12, wherein
the receiving hole of the control wheel has a stepped shape and has a mediate portion provided with a shoulder to stop the snap ring;
the snap ring is secured on the abutting portion of the drive head and abuts the shoulder of the control wheel to stop the drive head.

14. The wrench of claim 1, wherein the drive head is disposed between the control shaft and the control wheel.

15. The wrench of claim 2, wherein the elastic member is received in the receiving hole of the control wheel.

16. The wrench of claim 2, wherein the positioning hole of the drive head and the positioning ball are exposed outward from the receiving hole of the control wheel and the wrench body.

17. The wrench of claim 1, wherein
the positioning hole of the drive head is movable to align with the pressing recess of the control shaft so that the positioning ball is movable to align with the pressing recess of the control shaft;
when the positioning hole of the drive head is moved to misalign with the pressing recess of the control shaft, the positioning ball is pressed by the pressing recess of the control shaft and is moved to partially protrude outward from the positioning hole of the drive head;
when the positioning hole of the drive head is moved to align with the pressing recess of the control shaft, the positioning ball is partially inserted into the pressing recess of the control shaft and is retracted into the positioning hole of the drive head.
